(19) United States
(12) Patent Application Publication
(10) Pub. No.: US 2018/0337398 A1
(43) Pub. Date: Nov. 22, 2018

(54) NEGATIVE ELECTRODE ACTIVE MATERIAL AND NONAQUEOUS SECONDARY BATTERY

(71) Applicant: Panasonic Intellectual Property Management Co., Ltd., Osaka (JP)

(72) Inventors: MAYUMI MAENISHI, Osaka (JP); TAKAYUKI NAKATSUTSUMI, Osaka (JP); TETSUYUKI OKANO, Osaka (JP); NOBUHIKO HOJO, Tokyo (JP)

(21) Appl. No.: 15/974,312

(22) Filed: May 8, 2018

(30) Foreign Application Priority Data
May 16, 2017 (JP) 2017-097704
May 19, 2017 (JP) 2017-100120

(51) Int. Cl. H01M 4/36; H01M 4/38; H01M 4/587; H01M 10/0525; H01M 10/0569

(52) U.S. Cl. CPC H01M 4/364; H01M 4/38; H01M 2004/027; H01M 10/0525; H01M 10/0569; H01M 4/587

(57) ABSTRACT

A negative electrode active material for a nonaqueous secondary battery includes graphite containing boron. The graphite has a crystallite size Lc of 100 nm or more in the c-axis direction, In a Raman spectrum obtained by Raman spectroscopy of a surface of the graphite, a ratio R is 0.4 or more, the ratio R being a ratio of a maximum peak value Id of Raman intensity of a D band appearing in a Raman shift range of 1300 cm⁻¹ or more and 1400 cm⁻¹ or less to a maximum peak value Ig of Raman intensity of a G band appearing in a Raman shift range of 1500 cm⁻¹ or more and 1650 cm⁻¹ or less.

### BACKGROUND

### 1. Technical Field

The present disclosure relates to a nonaqueous secondary battery and a negative electrode active material to be used for the battery.

### 2. Description of the Related Art

As negative electrode materials for nonaqueous secondary batteries represented by a lithium ion secondary battery, boron-containing carbon materials have been studied (for example, see Japanese Unexamined Patent Application Publication Nos. 7-73898 and 9-63585).

International Publication No. WO 98/24134 discloses a nonaqueous secondary battery using a carbonaceous material as a negative electrode, where the carbonaceous material has a value obtained by dividing the Raman intensity at 1580 cm⁻¹ in Raman spectrum analysis by the Raman intensity at 1360 cm⁻¹ within a range of 4.0 or less, a crystallite size Lc in the c-axis direction, obtained by a wide angle X-ray diffraction method, of 25 to 35 nm, a boron content of 0.1 to 30 wt %, and a silicon or germanium content of 0.1 to 10 wt %.

### SUMMARY

There is a demand for a negative electrode active material for a nonaqueous secondary battery, in which a side reaction with an electrolyte solution has been suppressed.

One non-limiting and exemplary embodiment provides the followings.

In one general aspect, the techniques disclosed here feature a negative electrode active material for a nonaqueous secondary battery, including graphite containing boron, wherein the graphite has a crystallite size Lc of 100 nm or more in the c-axis direction; and in a Raman spectrum obtained by Raman spectroscopy of a surface of the graphite, a ratio R is 0.4 or more, the ratio R being a ratio of a maximum peak value Id of Raman intensity of a D band appearing in a Raman shift range of 1300 cm⁻¹ or more and 1400 cm⁻¹ or less to a maximum peak value Ig of Raman intensity of a G band appearing in a Raman shift range of 1500 cm⁻¹ or more and 1650 cm⁻¹ or less.

It should be noted that general or specific embodiments may be implemented as an element, a device, an apparatus, a method, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a partially cut plan view schematically illustrating the structure of a nonaqueous secondary battery according to an embodiment of the present disclosure;

FIG. 2 is a cross-sectional view of the nonaqueous secondary battery taken along the line II-II in FIG. 1;

FIG. 3A is a diagram illustrating a method of producing a negative electrode for performance evaluation;

FIG. 3B is a diagram illustrating the method of producing a negative electrode for performance evaluation;

FIG. 3C is a diagram illustrating the method of producing a negative electrode for performance evaluation; and

FIG. 4 is a graph showing Raman spectra of Example 2 and Comparative Example 1 for negative electrode active materials for nonaqueous secondary batteries according to an embodiment of the present disclosure.

### DETAILED DESCRIPTION

A lithium ion secondary battery using graphite in the negative electrode can occlude a large amount of lithium in the graphite skeleton and can reversibly release the lithium and therefore can achieve a high discharge capacity density. However, graphite has a problem of readily causing a side reaction with an electrolyte solution. The present inventors have diligently studied and, as a result, have found that a nonaqueous secondary battery that can suppress the side reaction with an electrolyte solution and has high reliability can be achieved by using specific graphite containing boron as a negative electrode active material and have arrived at the present disclosure. The reasons for that the a negative electrode active material for a nonaqueous secondary battery, which includes graphite containing boron, shows high reliability are not necessarily clear, and the followings are the views of the inventors. However, the present disclosure is not limited to the following views.

Embodiments of the present disclosure will now be described in detail. However, the disclosure is not limited to the following embodiments.

The negative electrode active material for a nonaqueous secondary battery according to an embodiment of the present disclosure includes graphite containing boron (hereinafter, also referred to as “B-containing graphite”). This B-containing graphite has a crystallite size Lc of 100 nm or more in the c-axis direction. In a Raman spectrum obtained by Raman spectroscopy of the B-containing graphite surface, the ratio R of a maximum peak value Id of Raman intensity of a D band appearing at a Raman shift of about 1360 cm⁻¹ to a maximum peak value Ig of Raman intensity of a G band appearing at a Raman shift of about 1580 cm⁻¹, R (Id/Ig), is 0.4 or more. The crystallite size Lc in the c-axis direction has no upper limit, but the upper limit may be, for example, 3000 nm.

The crystallite size Lc in the c-axis direction is a parameter showing the crystallinity of the graphite structure. Graphite has a structure in which hexagonal network layers composed of carbon atoms are regularly stacked. A larger crystallite size Lc means higher crystallinity in the laminating direction of the hexagonal network layers, i.e., a larger number of the regularly stacked hexagonal network layers. The crystallite size Lc can be determined using a wide angle X-ray diffraction method by applying the spread width of the diffraction line to Scherrer's equation.

In Raman spectroscopy of graphite, in general, two peaks, a peak appearing at a Raman shift of about 1580 cm⁻¹ and a peak appearing at a Raman shift of about 1360 cm⁻¹, are observed. Among these peaks, the peak appearing at a Raman shift of about 1580 cm⁻¹ is a peak common to graphite structures and is called a G band. In contrast, the peak appearing at a Raman shift of about 1360 cm⁻¹ is a peak caused by defects or structural disturbances of the graphite and is called a D band. Accordingly, the ratio of the maximum peak value Id of the D band to the maximum peak value Ig of the G band, the ratio R (i.e. Id/Ig), can serve as a parameter showing the abundance of defects or structural disturbances in the graphite. The peak positions and the peak widths of the G band and the D band are changeable depending on, for example, the B content in the graphite or the degree of the crystallinity. However, the peaks of the G band and the D band can be specified and isolated from the whole Raman spectrum. In the present specification, the Raman shift of about 1580 cm⁻¹ at which a G band appears is, for example, a Raman shift of 1500 cm⁻¹ or more and 1650 cm⁻¹ or less; and the Raman shift of about 1360 cm⁻¹ at which a D band appears is, for example, a Raman shift of 1300 cm⁻¹ or more and 1400 cm⁻¹ or less. Accordingly, it can also be said that the G band is a maximum peak appearing in a Raman shift range of 1500 cm⁻¹ or more and 1650 cm⁻¹ or less and that the D band is a maximum peak appearing in a Raman shift range of 1300 cm⁻¹ or more and 1400 cm⁻¹ or less.

In the negative electrode active material for a nonaqueous secondary battery according to an embodiment of the present disclosure, a crystallite size Lc of 100 nm or more and a Raman intensity ratio, R (i.e. Id/Ig), of 0.4 or more in a Raman spectrum obtained by Raman spectroscopy of a B-containing graphite surface mean that the B-containing graphite has crystallinity higher than a certain degree as graphite bulk and a certain amount or more of defects or structural disturbances on the graphite surface. It was demonstrated that the use of such B-containing graphite as a negative electrode active material can provide a secondary battery having high reliability, specifically, excellent cycle stability.

The factors that the nonaqueous secondary battery including the above-described B-containing graphite as the negative electrode active material has high reliability are not necessarily clear, but can be conceived as follows. In the followings, a process of releasing lithium ions from a negative electrode is defined as discharge, and a process of occluding lithium ions into a negative electrode is defined as charge.

In a negative electrode including graphite, a side reaction readily occurs. The reasons for this are believed that graphite has a low charge potential and a low discharge potential and therefore has a strong reducing power to readily cause a side reaction of reducing and decomposing the nonaqueous electrolyte solution on the negative electrode surface.

In contrast, in an embodiment of the present disclosure, the B-containing graphite is a large crystal having a crystallite size Lc of 100 nm or more in the c-axis direction. The Raman intensity ratio of the D band to the G band, R (i.e. Id/Ig), is 0.4 or more, and a certain amount or more of defects or structural disturbances of the graphite surface are present. As a result, a graphite surface chemically stable against the electrolyte solution may be formed in the presence of boron, due to the high degree of crystallinity of the inside of the B-containing graphite and defects or structural disturbances of the graphite surface. Alternatively, a dense coating film may be specifically formed at the interface between the B-containing graphite and the electrolyte solution, due to the high degree of crystallinity of the inside of the B-containing graphite and defects or structural disturbances of the graphite surface. It is believed that this stable graphite surface or coating film suppresses the continuous decomposition of the electrolyte solution to achieve a highly reliable secondary battery in which a side reaction is suppressed.

Raman intensity ratio R (i.e. Id/Ig) may be desirably 0.55 or less. When the Raman intensity ratio R is 0.55 or less, the crystallinity of the inside of the B-containing graphite is improved, and also the increments of the defects and the structural disturbances of the surface are appropriately controlled. As a result, a more stable surface or a more dense coating film can be formed, and the effect of suppressing a side reaction can be improved. More desirably, the Raman intensity ratio R may be within a range of 0.45 or more and 0.53 or less.

In addition, the crystallite size Lc may be desirably 400 nm or more. When the inside of graphite has crystallinity such that the crystallite size Lc is 400 nm or more, in addition to the increases of the defects and the structural disturbances of the surface, the crystallinity of the inside of the B-containing graphite is appropriately controlled. As a result, a more stable surface or a more dense coating film can be formed, and the effect of suppressing a side reaction can be improved. The crystallite size Lc may be more desirably 492 nm or more and further desirably 538 nm or more.

The content of boron in the B-containing graphite may be desirably 0.01 mass % or more and 5 mass % or less. By restricting the rate of boron in graphite to 5 mass % or less, by-products not participating in occlusion and release of lithium ions are prevented from being generated, and a high discharge capacity density can be obtained. In addition, by restricting the rate of boron in graphite to 0.01 mass % or more, a sufficient effect of suppressing a side reaction can be obtained. Considering reliability and discharge capacity density, the content of boron in graphite may be desirably 0.01 mass % or more and 5 mass % or less.

More desirably, a stable surface or a dense coating film may be formed by controlling the content of boron in graphite to 0.06 mass % or more and 0.7 mass % or less to effectively improve the effect of preventing a side reaction. Further desirably, the content of boron in graphite may be 0.29 mass % or more and 0.42 mass % or less.

A Raman intensity ratio R (i.e. Id/Ig) of 0.4 or more means that a certain amount or more of defects or structural disturbances are generated on the surface of the B-containing graphite, but does not mean that a large number of defects are also present inside the graphite. The side reaction with an electrolyte solution varies depending on the surface state of graphite. In the present disclosure, it is believed that the side reaction is prevented from occurring by controlling the surface state through introduction of defects or structural disturbances. At the same time, regarding the state of the inside of graphite, an amount of defects may be desirably smaller to provide a high discharge capacity. Accordingly, in the production of a negative electrode active material, as described later, graphite having high crystallinity and few defects is synthesized and may be then subjected to treatment of intentionally introducing defects and structural disturbances to the surface.

The ratio R on the graphite surface can be calculated by, for example, micro-Raman spectroscopy using laser light having a wavelength of 514.5 nm.

The method of synthesizing the negative electrode active material includes, for example, the following procedure.

A carbon precursor material as a raw material is fired in an inert atmosphere at about 2100° C. to 3000° C. to promote the graphitization. On this occasion, a higher firing temperature can provide graphite having higher crystallinity, i.e., a larger crystallite size Lc in the c-axis direction measured by a wide angle X-ray diffraction method. In order to obtain a large crystallite size Lc of 100 or more, the firing temperature may be desirably 2500° C. or more and further desirably 2800° C. or more.

In addition, in the firing, defects and structural disturbances are induced on the graphite surface by adding a boron raw material to the carbon precursor material, mixing them, and firing the mixture. As a result, graphite having a ratio R of 0.4 or more can be easily produced. The boron raw material may be added at the time of graphitizing carbon or may be added after the graphitization and be fired again.

Furthermore, in order to introduce defects or structural disturbances to the graphite surface, the graphite obtained by firing may be appropriately pulverized and treated with a ball mill. Alternatively, heat treatment may be performed under an inert atmosphere. The heat treatment temperature under an inert atmosphere may be desirably about 1900° C. to 2800° C.

Graphite is a generic name of carbon materials including a region having a structure in which hexagonal network layers composed of carbon atoms are regularly stacked, and examples thereof include natural graphite, artificial graphite, and graphitized mesophase carbon particles. The spacing (the spacing between a carbon layer and another carbon layer) d₀₀₂ of the (002) plane measured by an X-ray diffraction method is used as an index showing the degree of growth of the graphite-type crystal structure. In general, high crystalline carbon having a spacing d₀₀₂ of 3.4 angstrom or less and a crystallite size of 100 angstrom or more is defined as graphite.

The carbon precursor material can be soft carbon, such as petroleum coke and coal coke. The soft carbon may have, for example, a sheet, fiber, or particle shape. Considering the processing after firing, the soft carbon may be desirably a particulate or short fibrous synthetic resin having a size of several to several tens of micrometers. Alternatively, the carbon as a raw material can be obtained by treating an organic material, such as a synthetic resin, with heat of about 800° C. to 1000° C. to evaporate elements other than carbon.

Examples of the boron raw material to be desirably used include boron simple substance, boric acid, boron oxide, boron nitride, and diborides such as aluminum diboride and magnesium diboride. The ratio of the carbon and boron raw material may be 0.01% to 5% as a mass ratio of boron to carbon. In high-temperature firing, a part of boron may scatter without being incorporated into the carbon material. Accordingly, the amount of boron included in the carbon material after the firing may be decreased compared to that before the firing. The boron raw material may be added after the graphitization treatment of carbon.

An example of the nonaqueous secondary battery including the negative electrode active material will now be described.

The nonaqueous secondary battery includes a positive electrode, a negative electrode, and a nonaqueous electrolyte solution.

The positive electrode includes a positive electrode active material that can occlude and release an alkali metal ion. The negative electrode includes a negative electrode active material, and the negative electrode active material includes graphite containing boron and having a crystallite size Lc and a Raman intensity ratio R satisfying the above-described requirements. The nonaqueous electrolyte solution includes an alkali metal salt composed of an alkali metal ion and an anion in a state of being dissolved in a nonaqueous solvent. The nonaqueous solvent includes, for example, a chain carboxylic acid ester having one or more fluorine groups. The alkali metal ion may be a lithium ion.

This structure of the nonaqueous secondary battery can achieve a battery having a high energy density and high reliability.

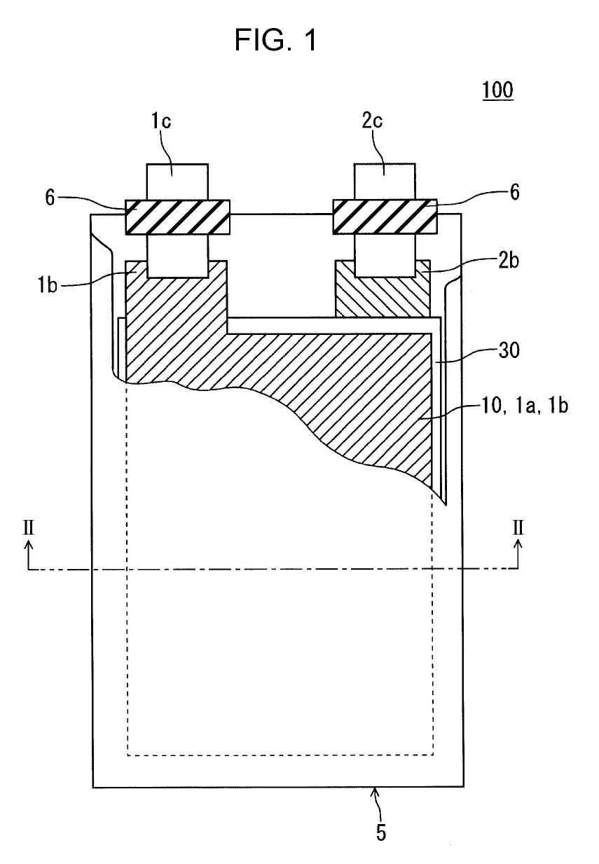

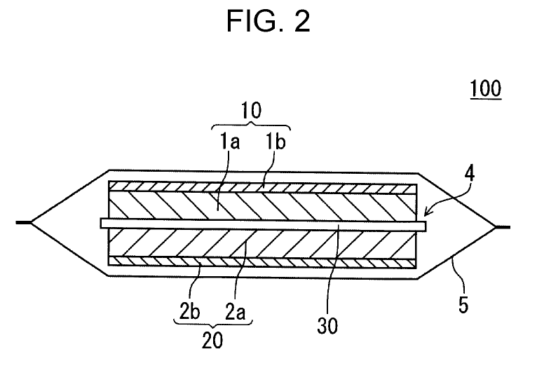

A lithium ion secondary battery will now be described as an example of the nonaqueous secondary battery according to an embodiment of the present disclosure with referring to FIGS. 1 and 2. FIG. 1 is a partially cut plan view schematically illustrating an example of the structure of a nonaqueous secondary battery (e.g. lithium ion secondary battery). FIG. 2 is a cross-sectional view taken along the line II-II in FIG. 1.

As shown in FIGS. 1 and 2, the lithium ion secondary battery 100 is a sheet-type battery and includes an electrode plate group 4 and an outer packaging case 5 accommodating the electrode plate group 4.

The electrode plate group 4 has a structure composed of a positive electrode 10, a separator 30, and a negative electrode 20 stacked in this order. The positive electrode 10 and the negative electrode 20 face each other with the separator 30 therebetween to form the electrode plate group 4. The electrode plate group 4 is impregnated with a nonaqueous electrolyte solution (not shown).

The positive electrode 10 includes a positive electrode mixture layer 1a and a positive electrode collector 1b. The positive electrode mixture layer 1a is disposed on the positive electrode collector 1b.

The negative electrode 20 includes a negative electrode mixture layer 2a and a negative electrode collector 2b. The negative electrode mixture layer 2a is disposed on the negative electrode collector 2b.

The positive electrode collector 1b is connected to a positive electrode tab lead 1c, and the negative electrode collector 2b is connected to a negative electrode tab lead 2c. The positive electrode tab lead 1c and the negative electrode tab lead 2c each extend to the outside of the outer packaging case 5.

The positive electrode tab lead 1c and the outer packaging case 5 are insulated from each other by an insulation tab film 6, and the negative electrode tab lead 2c and the outer packaging case 5 are insulated from each other by an insulation tab film 6.

The positive electrode mixture layer 1a includes a positive electrode active material that can occlude and release an alkali metal ion. The positive electrode mixture layer 1a may optionally include a conduction assistant, an ion conductor, and a binder. As the positive electrode active material, the conduction assistant, the ion conductor, and the binder, known materials can be used without specific limitations.

The positive electrode active material may be any material that occludes and releases one or more alkali metal ions, and may be, for example, an alkali metal-containing transition metal oxide, transition metal fluoride, polyanionic material, fluorinated polyanionic material, or transition metal sulfide. The positive electrode active material may be, for example, a lithium-containing transition metal oxide, such as LiₓMe_{y}O₂ and Li₁₊ₓMe_{y}O₃ (where, 0<x≤1, 0.95≤y<1.05, Me includes at least one selected from the group consisting of Co, Ni, Mn, Fe, Cr, Cu, Mo, Ti, and Sn); a lithium-containing polyanionic material, such as LiₓMe_{y}PO₄ and LiₓMe_{y}P₂O₇ (where, 0≤x≤1, 0.95≤y<1.05, Me includes at least one selected from the group consisting of Co, Ni, Mn, Fe, Cu, and Mo); or a sodium-containing transition metal oxide, such as NaₓMe_{y}O₂ (where, 0<x≤1, 0.95≤y<1.05, Me is at least one selected from the group consisting of Co, Ni, Mn, Fe, Cr, Cu, Mo, Ti, and Sn).

The positive electrode collector 1b can be a sheet or film made of a metal material. The metal material may be, for example, aluminum, an aluminum alloy, stainless steel, nickel, or a nickel alloy. The sheet or film may be porous or may be non-porous. Aluminum and alloys thereof are inexpensive and can be easily formed into a thin film and are therefore desirable as materials of the positive electrode collector 1b. The surface of the positive electrode collector 1b may be coated with a carbon material, such as carbon, for, for example, reducing the resistance value, giving a catalytic effect, and strengthening the bond between the positive electrode mixture layer 1a and the positive electrode collector 1b.

The negative electrode mixture layer 2a includes, as a negative electrode active material, a graphite material containing boron of the embodiment at least on the surface. The negative electrode mixture layer 2a may optionally further include another negative electrode active material that can occlude and release an alkali metal ion. The negative electrode mixture layer 2a may optionally include a conduction assistant, an ion conductor, and a binder. As the active material, the conduction assistant, the ion conductor, and the binder, known materials can be used without specific limitations.

The negative electrode active material that can be used together with the negative electrode active material of the embodiment is, for example, a material occluding and releasing an alkali metal ion and an alkali metal. Examples of the material occluding and releasing an alkali metal ion include alkali metal alloys, carbons, transition metal oxides, and silicon materials. Specifically, as the negative electrode material of a lithium secondary battery, for example, alloys of a metal, such as Zn, Sn, and Si, and lithium; carbons, such as artificial graphite, natural graphite, and hardly graphitizable amorphous carbon; transition metal oxides, such as Li₄Ti₅O₁₂, TiO₂, and V₂O₅; SiOₓ (0<x≤2); and lithium metal can be used.

As the conduction assistant, for example, carbon materials, such as carbon black, graphite, and acetylene black; and conductive polymers, such as polyaniline, polypyrrole, and polythiophene can be desirably used. As the ion conductor, for example, gel electrolytes, such as polymethyl methacrylate; and solid electrolytes, such as polyethylene oxide, lithium phosphate, and lithium phosphate oxynitride (LiPON) can be used. As the binder, for example, polyvinylidene fluoride, vinylidene fluoride-hexafluoropropylene copolymer, vinylidene fluoride-tetrafluoroethylene copolymer, polytetrafluoroethylene, carboxymethyl cellulose, polyacrylic acid, styrene-butadiene copolymer rubber, polypropylene, polyethylene, and polyimide can be used.

The negative electrode collector 2b can be a sheet or film made of a metal material. The metal material may be, for example, aluminum, an aluminum alloy, stainless steel, nickel, a nickel alloy, copper, or a copper alloy. The sheet or film may be porous or may be non-porous. Copper and copper alloys are stable also at the operation potential of the negative electrode and are relatively inexpensive and are therefore desirable as materials of the negative electrode collector 2b. As the sheet or film, for example, metal foil or metal mesh is used. The surface of the negative electrode collector 2b may be coated with a carbon material, such as carbon, for, for example, reducing the resistance value, giving a catalytic effect, and strengthening the bond between the negative electrode mixture layer 2a and the negative electrode collector 2b.

The separator 30 is a porous film made of, for example, polyethylene, polypropylene, glass, cellulose, or a ceramic material. The pores of the separator 30 are impregnated with a nonaqueous electrolyte solution.

The nonaqueous electrolyte solution consists of an alkali metal salt dissolved in a nonaqueous solvent. As the nonaqueous solvent, a known solvent, such as a cyclic carbonic acid ester, a chain carbonic acid ester, a cyclic carboxylic acid ester, a chain carboxylic acid ester, a chain nitrile, a cyclic ether, and a chain ether, can be used. From the viewpoint of the solubility of a Li salt and the viscosity, the nonaqueous electrolyte solution may desirably include a cyclic carbonic acid ester and a chain carbonic acid ester.

As the cyclic carbonic acid ester, for example, ethylene carbonate, fluoroethylene carbonate, propylene carbonate, butylene carbonate, vinylene carbonate, vinylethylene carbonate, and derivatives thereof can be used. These esters may be used alone or in combination of two or more thereof. From the viewpoint of the ionic conductivity of the electrolyte solution, at least one selected from the group consisting of ethylene carbonate, fluoroethylene carbonate, and propylene carbonate may be desirably used.

As the chain carbonic acid ester, for example, dimethyl carbonate, ethyl methyl carbonate, and diethyl carbonate can be used. These esters may be used alone or in combination of two or more thereof.

As the cyclic carboxylic acid ester, for example, y-butyrolactone and y-valerolactone can be used. These esters may be used alone or in combination of two or more thereof.

As the chain carboxylic acid ester, for example, methyl acetate, ethyl acetate, propyl acetate, methyl propionate, ethyl propionate, and propyl propionate can be used. These esters may be used alone or in combination of two or more thereof.

As the chain nitrile, for example, acetonitrile, propionitrile, butyronitrile, valeronitrile, isobutyronitrile, and pivalonitrile can be used. These nitriles may be used alone or in combination of two or more thereof.

As the cyclic ether, for example, 1,3-dioxolane, 1,4-dioxolane, tetrahydrofuran, and 2-methyltetrahydrofuran can be used. These ethers may be used alone or in combination of two or more thereof.

As the chain ether, for example, 1,2-dimethoxyethane, dimethyl ether, diethyl ether, dipropyl ether, ethyl methyl ether, diethylene glycol dimethyl ether, diethylene glycol diethyl ether, and diethylene glycol dibutyl ether can be used. These ethers may be used alone or in combination of two or more thereof.

These solvents may be fluorinated solvents in which a part of hydrogen atoms are appropriately substituted with fluorine.

As the alkali metal salt to be dissolved in the nonaqueous solvent, for example, lithium salts, such as LiClO₄, LiBF₄, LiPF₆, LiN(SO₂F)₂, LiN(SO₂CF₃)₂, and lithium bis(oxalate)borate (LiBOB); and sodium salts, such as NaClO₄, NaBF₄, NaPF₆, NaN(SO₂F)₂, and NaN(SO₂CF₃)₂ can be used. In particular, from the viewpoint of the overall characteristics of a nonaqueous electrolyte solution secondary battery, a lithium salt may be desirably used. From the viewpoint of, for example, ionic conductivity, at least one selected from LiBF₄, LiPF₆, and LiN(SO₂F)₂ may be desirably used.

The molar content of the alkali metal salt in the nonaqueous electrolyte solution according to the embodiment is not particularly limited and may be desirably 0.5 mol/L or more and 2.0 mol/L or less. It has been reported that a high salt concentration electrolyte solution having a molar ratio of the alkali metal salt to a solvent of 1:1 to 1:4 can also be charged and discharged as in ordinary electrolyte solutions, and the electrolyte solution may be such a high concentration electrolyte solution.

The type (shape) of a secondary battery is not limited to a sheet type as shown in FIGS. 1 and 2 and is, for example, a coin type, a button type, a laminate type, a cylinder type, a flat type, or a square type. The nonaqueous secondary battery of the embodiment can be applied to any shape of a nonaqueous secondary battery. The secondary battery of the embodiment can be used in, for example, a mobile information terminal, portable electronic equipment, a domestic power storage device, an industrial power storage device, a motorcycle, an EV, or a PHEV, but the use of the secondary battery is not limited thereto.

Embodiments of the present disclosure will now be further described based on examples.

### Example 1

### (1) Synthesis of Negative Electrode Active Material

A boric acid raw material (CAS No. 10043-35-3) was added to a petroleum coke powder having an average particle diameter of 12 μm, and the mixture was pulverized and mixed with an agate mortar. Herein, the amount of the boron raw material was 10 mass % based on the amount of the petroleum coke powder. The rate of boron to the petroleum coke powder was 1.7 mass %. The mixture was then fired at 2800° C. in an Atchison furnace. The resulting carbon material was further re-fired at 1900° C. in a tube furnace under an argon atmosphere (argon gas flow rate: 1 L/min). The heating was then stopped, and after natural cooling, the carbon material was taken out from the tube furnace. The carbon material obtained through the above-described process was pulverized with an agate mortar and was subjected to treatment with a ball mill for introducing defects and structural disturbances to the graphite surface. The carbon material was then classified by a stainless steel standard sieve having an aperture of 40 μm. Thus, a negative electrode active material for a nonaqueous secondary battery was obtained.

The boron content of graphite in the resulting negative electrode active material was measured by inductively coupled plasma (ICP) emission spectroscopy and was 0.36 mass %. It was demonstrated that the graphite contained boron.

The crystallite size Lc was calculated by a wide angle X-ray diffraction method. The calculation of the crystallite size Lc was calculated based on a method for evaluating the lattice constant and the size of crystallite of a carbon powder material using an X-ray diffractometer, established by the 117th Committee in Japan Society for the Promotion of Science. Specifically, the diffraction profile of the graphite (002) plane was measured using a Si standard sample as internal standard, and the lattice constant and the crystallite size Lc were calculated.

In addition, micro-Raman spectroscopy was performed using laser light with an excitation wavelength of 514.5 nm. From the measured Raman spectrum (Stokes line), the height Id of the peak appearing at a Raman shift of about 1360 cm⁻¹ derived from the graphite D-band and the height Ig of the peak appearing at a Raman shift of about 1580 cm⁻¹ derived from the graphite G-band were determined, and the Raman intensity ratio R (i.e. Id/Ig) was calculated. Specifically, base lines were drawn at a Raman shift range of about 1250 cm⁻¹ to 1450 cm⁻¹ and at a Raman shift range of about 1500 cm⁻¹ to 1700 cm⁻¹, and the heights Id and Ig of the peaks from the respective base lines were determined, and the ratio R was calculated.

### (2) Production of Test Electrode

The negative electrode active material for a nonaqueous secondary battery, which is synthesized by the above-described method, carboxymethyl cellulose (CAS No. 9000-11-7), and a styrene-butadiene copolymer rubber (CAS No. 9003-55-8) were weighed at a weight ratio of 97:2:1 and were dispersed in pure water to prepare a slurry. The slurry was then applied at a thickness of 10 μm onto a negative electrode collector 2b of copper foil with a coater. The coating film was rolled with a roller to obtain an electrode plate.

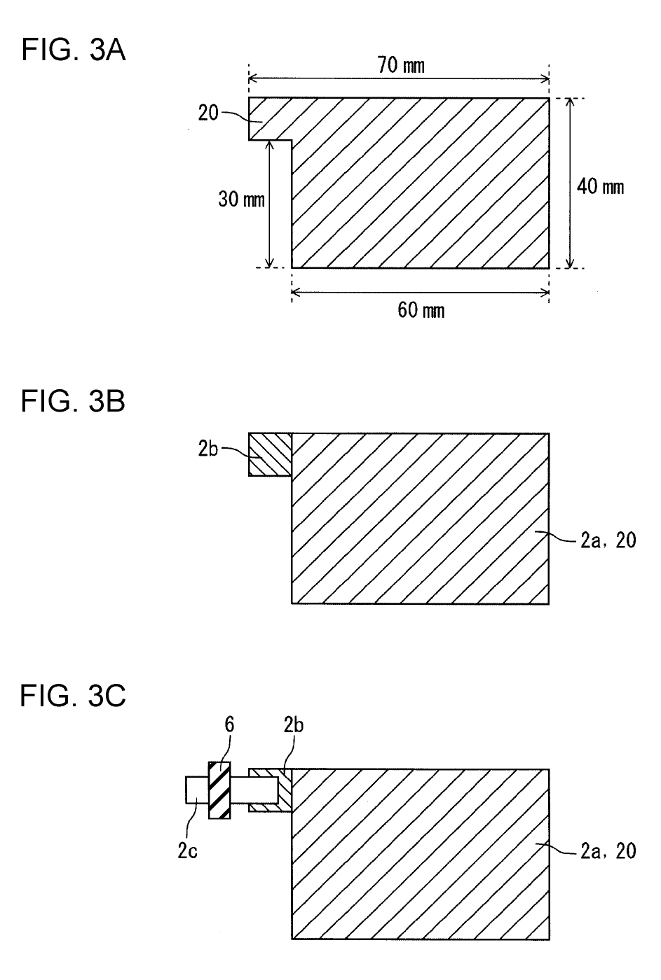

The rolled electrode plate was then cut into the shape shown in FIG. 3A to prepare a negative electrode 20 for performance evaluation. In FIG. 3A, the region of 60 mm×40 mm functions as a negative electrode, and the protruding portion of 10 mm×10 mm is a connection region with a tab lead 2c. Furthermore, as shown in FIG. 3B, the negative electrode mixture layer 2a formed on the connection region was then scraped to expose the negative electrode collector (copper foil) 2b. As shown in FIG. 3C, the exposed portion of the negative electrode collector (copper foil) 2b was then connected to a negative electrode tab lead 2c, and a predetermined circumferential region of the negative electrode tab lead 2c was covered with an insulation tab film 6.

### (3) Preparation of Nonaqueous Electrolyte Solution

LiPF₆ (CAS No. 21324-40-3) was dissolved at a concentration of 1.2 mol/L in a solvent mixture of fluoroethylene carbonate (CAS No. 114435-02-8) and dimethyl carbonate (CAS No. 616-38-6) at a volume ratio of 1:4 to prepare an electrolyte solution. The preparation of the electrolyte solution was performed in a glove box under an Ar atmosphere with a dew point of −60° C. or less and an oxygen value of 1 ppm or less.

### (4) Production of Evaluation Cell

A half-cell for negative electrode evaluation including lithium metal as the counter electrode was produced using the negative electrode for performance evaluation. The production of the evaluation cell was performed in a glove box under an Ar atmosphere with a dew point of −60° C. or less and an oxygen value of 1 ppm or less.

The negative electrode for performance evaluation equipped with a negative electrode tab lead 2c and the Li metal counter electrode equipped with a nickel tab lead 1c were disposed such that the electrodes just faced each other with a polypropylene separator 30 (thickness: 30 μm) therebetween to prepare an electrode plate group 4.

An Al laminate film (thickness: 100 μm) cut into a square of 120×120 mm was folded in half, and the end on the long side of 120 mm was thermally sealed at 230° C. to form a tube of 120×60 mm. The produced electrode plate group 4 was then placed in the tube from one short side of 60 mm. The positions of the end face of the Al laminate film and the thermal welding resin of the tab leads 1c and 2c were adjusted, followed by thermal sealing at 230° C. A nonaqueous electrolyte solution (0.3 cm³) was then poured into the Al laminate film tube from the short side not thermally sealed, followed by being left to stand under a reduced pressure of 0.06 MPa for 15 minutes to impregnate the negative electrode mixture layer 2a with the electrolyte solution. Finally, the end face of the Al laminate film from which the electrolyte solution was poured was thermally sealed at 230° C.

### (5) Evaluation of Battery

The evaluation cell produced as in above was pressurized and fixed with cramps at 0.2 MPa such that the electrode plate group 4 is sandwiched with stainless steel (thickness: 2 mm) of 80×80 cm through the laminate film.

In a thermostatic chamber of 25° C., charge and discharge were repeated 5 cycles while restricting the current flowing during charge and discharge such that the current density per mass of the negative electrode active material was 20 mA. The charge was terminated at a negative electrode potential of 0.0 V (based on Li counter electrode), and the discharge was terminated at a negative electrode potential of 1.0 V (based on Li counter electrode). The battery was left to stand at open circuit for 20 minutes between charge and discharge.

Subsequently, in a thermostatic chamber of 45° C., charge and discharge were repeated 30 cycles while restricting the current flowing during charge and discharge such that the current density per mass of the negative electrode active material was 20 mA. The charge was terminated at a negative electrode potential of 0.0 V (based on Li counter electrode), and the discharge was terminated at a negative electrode potential of 1.0 V (based on Li counter electrode). The battery was left to stand at open circuit for 20 minutes between charge and discharge.

Subsequently, the negative electrode discharged down to 1.0 V (based on Li counter electrode) was taken out and was subjected to ICP emission spectroscopy. Lithium was quantitatively analyzed by ICP emission spectroscopy, and the resulting amount of Li per weight of graphite was defined as the amount of negative electrode side reaction.

### Example 2

A negative electrode active material for a nonaqueous secondary battery was synthesized as in Example 1 except that the temperature of re-firing under an argon atmosphere was 2300° C.

The boron content of graphite in the resulting negative electrode active material was measured by ICP emission spectroscopy and was 0.29 mass %. It was demonstrated that the graphite contained boron.

### Example 3

A negative electrode active material for a nonaqueous secondary battery was synthesized as in Example 2 except that the amount of the boron raw material added at the time of firing graphite was 20 mass % based on the amount of the petroleum coke powder. The rate of boron to the petroleum coke powder was 3.4 mass %.

The boron content of graphite in the negative electrode active material was measured by ICP emission spectroscopy and was 0.42 mass %. It was demonstrated that the graphite contained boron.

### Example 4

A negative electrode active material for a nonaqueous secondary battery was synthesized as in Example 3 except that the temperature of re-firing under an argon atmosphere was 2800° C.

The boron content of graphite in the negative electrode active material was measured by ICP emission spectroscopy and was 0.39 mass %. It was demonstrated that the graphite contained boron.

### Example 5

A negative electrode active material for a nonaqueous secondary battery was synthesized as in Example 1 except that the temperature of re-firing under an argon atmosphere was 2800° C.

The boron content of graphite in the negative electrode active material was measured by ICP emission spectroscopy and was 0.36 mass %. It was demonstrated that the graphite contained boron.

### Comparative Example 1

A negative electrode active material for a nonaqueous secondary battery was synthesized as in Example 1 except that the boron raw material (i.e. boric acid) was not added at the time of synthesizing graphite and that re-firing under an argon atmosphere was not performed.

The boron content of graphite in the negative electrode active material was measured by ICP emission spectroscopy, and boron was not detected.

### Comparative Example 2

A negative electrode active material for a nonaqueous secondary battery was synthesized as in Example 2 except that the amount of the boron raw material added at the time of firing graphite was 1 mass % based on the amount of the petroleum coke powder. The rate of boron to the petroleum coke powder was 0.17 mass %.

The boron content of graphite in the negative electrode active material was measured by ICP emission spectroscopy and was 0.03 mass %. It was demonstrated that the graphite contained boron.

### Comparative Example 3

A negative electrode active material for a nonaqueous secondary battery was synthesized as in Example 2 except that acetylene black was used instead of the petroleum coke powder as the carbon precursor material.

The boron content of graphite in the negative electrode active material was measured by ICP emission spectroscopy and was 0.2 mass %. It was demonstrated that the graphite contained boron.

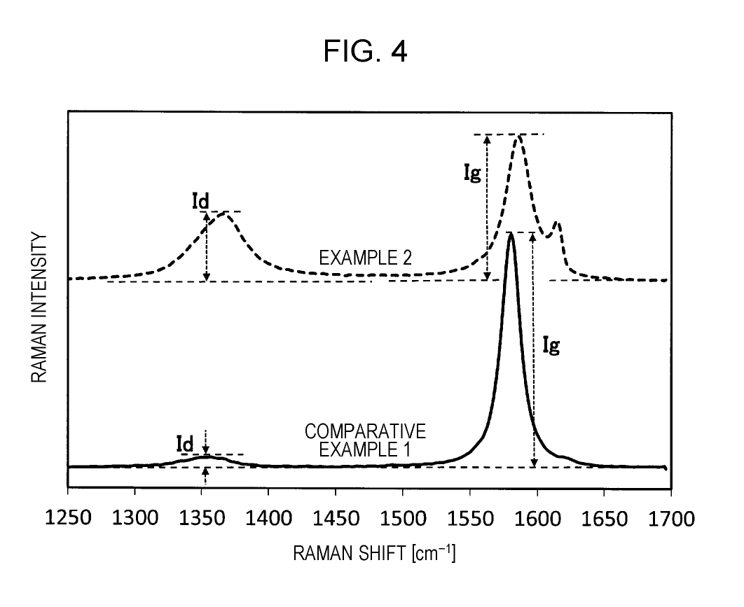

FIG. 4 shows Raman spectra of graphite surfaces of negative electrode active materials of Example 2 and Comparative Example 1 by micro-Raman spectroscopy as an example. As shown in FIG. 4, although the peak positions slightly change according to the addition amount of boron, spectral peaks are observed at Raman shifts of about 1360 cm⁻¹ (i.e. D band) and about 1580 cm⁻¹ (i.e. G band). A comparison between Example 2 and Comparative Example 1 demonstrates that in Example 2, the D band spectrum is large, and the maximum peak value Id is increased to give a large ratio R (i.e. Id/Ig), compared to those in Comparative Example 1. FIG. 4 shows the graphite surface of Example 2 has many defects or large structural disturbances compared to those of Comparative Example 1, which is believed to be mainly resulted from the defects or structural disturbances of the graphite surface caused by the addition of boron. The peak appearing at a Raman shift of about 1620 cm⁻¹ observed in Example 2 is believed as a peak resulted from the edge surface of the graphite containing boron.

Batteries were produced as in Example 1 using the negative electrode active materials of Examples 2 to 5 and Comparative Examples 1 to 3 and were evaluated as in Example 1. The results are shown in Table 1, where the amount of side reaction is expressed as a side reaction rate (percentage) relative to the value in Comparative Example 1. Table 1 also shows the crystallite size Lc in the c-axis direction of the graphite material and the Raman intensity ratio R (i.e. Id/Ig) of the G band to the D band of the graphite, in each of Examples 1 to 5 and Comparative Examples 1 to 3.

As shown in Table 1, in all the negative electrode active materials of Examples 1 to 5, the crystallite size Lc of the graphite was 100 nm or more (or 400 nm or more), and the Raman intensity ratio R (i.e. Id/Ig) was 0.4 or more and 0.55 or less. It was demonstrated that the use of the negative electrode active materials of Examples 1 to 5 reduces the side reaction rate to 76% to 64% based on that in Comparative Example 1 and enhances the crystallinity of graphite bulk and that the introduction of defects and structural disturbances to the graphite surface can suppress the side reaction.

In particular, the side reaction rate was decreased with an increase of the ratio R from the ratio R of 0.45 in Example 1 to the ratio R of 0.53 in Example 4, which suggests that there is any relationship between the suppression of side reaction and the presence of defects and structural disturbances on the graphite surface.

Focusing on the boron contents in graphite of the negative electrode active materials of Examples 1 to 5, the side reaction rate is apt to decrease with an increase in the boron content. However, the side reaction rate is not necessarily decreased with an increase in the boron content. For example, although the boron contents in Examples 1 and 5 are the same, 0.36 mass %, a large difference in the side reaction rates, 76% in Example 1 and 66% in Example 5, is caused depending on the ratio R. In comparison between Example 3 and Example 4, although the boron content in Example 4 is smaller than that in Example 3, the side reaction rate in Example 4 is lower than that in Example 3, that is, the side reaction in Example 4 is reduced.

As described above, in the negative electrode active materials of Examples 1 to 5, the direct factor for decreasing the side reaction rate is presumed to be an increase in the ratio R, i.e., the introduction of defects or structural disturbances on the graphite surface. It is sufficiently reasonable from the relationship between the boron content and the side reaction rate to believe that the defects or structural disturbances are induced by boron on the graphite surface. The addition of boron can be said as one approach for controlling the ratio R to 0.4 or more and obtaining a graphite interface where the side reaction with an electrolyte solution is suppressed.

In comparison among negative electrode active materials of Examples 1, 2, and 5 where the temperatures of re-firing under an argon atmosphere are different from one another, an increase in the re-firing temperature increases the ratio R and the crystallite size Lc and consequently decreases the side reaction rate. That is, in B-containing graphite, heat treatment under an inert atmosphere increases the crystallinity of graphite bulk and also increases the defects and structural disturbances of the graphite surface.

In contrast, in the negative electrode active material including graphite not containing boron of Comparative Example 1, although the crystallite size Lc was 100 nm or more, the ratio R value was small, 0.05. The negative electrode active material of Comparative Example 1 had a ratio R of less than 0.4 and insufficient defects or structural disturbances of the graphite surface, and therefore the side reaction was larger than that of any of the negative electrode active materials in Examples 1 to 5. In general, in graphite not containing boron, it is thought that an increase in the crystallinity of the graphite (e.g. an increase in the crystallite size Lc) is accompanied with decreases in the defect and the structural disturbance of the graphite surface and that achievement of a high ratio R is difficult.

Although the negative electrode active material of Comparative Example 2 includes graphite containing boron and has a crystallite size Lc of 100 nm or more, the ratio R was 0.14, i.e., less than 0.4. As a result, the side reaction rate of the negative electrode active material of Comparative Example 2 was slightly decreased compared to that in Comparative Example 1, but was significantly large compared to that of any of the negative electrode active materials of Examples 1 to 5. This is presumed to be caused by that the ratio R in Comparative Example 2 is less than 0.4 and the defects or structural disturbances of the graphite surface are insufficient as in Comparative Example 1.

Although the negative electrode active material of Comparative Example 3 included graphite having a ratio R of 0.50, i.e., higher than 0.4, the crystallite size Lc was 80 nm, i.e., less than 100 nm. The results of the evaluation show a side reaction rate of 562% and a side reaction increased to 5.62 times that in Comparative Example 1. This significantly large amount of side reaction, compared to any of the graphite materials of Examples 1 to 5 and also Comparative Examples 1 and 2, is thought to be due to the insufficient crystallinity of the inside of graphite.

The results described above demonstrate that when graphite containing boron described below is used as a negative electrode active material of a nonaqueous secondary battery, the side reaction with the electrolyte solution is suppressed, and the secondary battery has excellent cycling characteristics. The graphite has a crystallite size Lc of 100 nm or more in the c-axis direction, and the graphite also has, in a Raman spectrum obtained by Raman spectroscopy of the graphite surface, a ratio R of 0.4 or more, the ratio R being a ratio of a maximum peak value Id of Raman intensity of a D band appearing at a Raman shift of about 1360 cm⁻¹ to a maximum peak value Ig of Raman intensity of a G band appearing at a Raman shift of about 1580 cm⁻¹. The causes of this are presumed that a specific interfacial structure stable against the electrolyte solution was formed at the interface between the electrolyte solution and the graphite due to the high crystallinity in the c-axis direction of the inside of the graphite and the defects or structural disturbances of the graphite surface to suppress the side reaction. Possible examples of the defects and the structural disturbances of the graphite surface are defects derived from boron on the graphite surface and structural disturbances induced by the boron.

TABLE 1

| | | | | Side reaction |
|---|---|---|---|---|
| Negative electrode | | | Lc | rate |
| active material | Containing of B | Id/Ig | [nm] | [%] |
| Example 1 | Yes | 0.45 | 492 | 76% |
| Example 2 | Yes | 0.48 | 538 | 73% |
| Example 3 | Yes | 0.50 | 1143 | 66% |
| Example 4 | Yes | 0.53 | 599 | 64% |
| Example 5 | Yes | 0.53 | 841 | 66% |
| Comparative | No | 0.05 | 269 | 100% |
| Example 1 | | | | |
| Comparative | Yes | 0.14 | 543 | 99% |
| Example 2 | | | | |
| Comparative | Yes | 0.50 | 80 | 562% |
| Example 3 | | | | |

The negative electrode active material according to the present disclosure can be used in a nonaqueous secondary battery and is particularly useful as a negative electrode material of a nonaqueous secondary battery, such as a lithium ion secondary battery.

What is claimed is:

1. A negative electrode active material for a nonaqueous secondary battery, comprising graphite containing boron, wherein
the graphite has a crystallite size Lc of 100 nm or more in the c-axis direction; and
in a Raman spectrum obtained by Raman spectroscopy of a surface of the graphite, a ratio R is 0.4 or more, the ratio R being a ratio of a maximum peak value Id of Raman intensity of a D band appearing in a Raman shift range of 1300 cm⁻¹ or more and 1400 cm⁻¹ or less to a maximum peak value Ig of Raman intensity of a G band appearing in a Raman shift range of 1500 cm⁻¹ or more and 1650 cm⁻¹ or less.

2. The negative electrode active material according to claim 1, wherein the ratio R is 0.4 or more and 0.55 or less.

3. The negative electrode active material according to claim 1, wherein the crystallite size Lc is 400 nm or more.

4. The negative electrode active material according to claim 1, wherein a content of boron in the graphite is 0.01 mass % or more and 5 mass % or less.

5. The negative electrode active material according to claim 4, wherein the content of boron in the graphite is 0.06 mass % or more and 0.7 mass % or less.

6. A nonaqueous secondary battery comprising:
a positive electrode including a positive electrode active material capable of occluding and releasing an alkali metal ion;
a negative electrode including the negative electrode active material according to claim 1; and
a nonaqueous electrolyte solution.

7. The nonaqueous secondary battery according to claim 6, wherein the alkali metal ion is a lithium ion.

8. The nonaqueous secondary battery according to claim 6, wherein the nonaqueous electrolyte solution includes a nonaqueous solvent including a chain carboxylic acid ester having one or more fluorine groups.
